(19) United States
(12) Patent Application Publication
(10) Pub. No.: US 2007/0093200 A1
(43) Pub. Date: Apr. 26, 2007

(54) Communications device for communicating between a vehicle and a call center

(75) Inventor: Paul J. Dobosz, Noblesville, IN (US)

Correspondence Address: DELPHI TECHNOLOGIES, INC., M/C 480-410-202, PO BOX 5052, TROY, MI, 48007, US

(73) Assignee: DELPHI TECHNOLOGIES, INC., TROY, MI (US)

(21) Appl. No.: 11/255,409

(22) Filed: Oct. 21, 2005

(51) Int. Cl. H04H 1/00

(52) U.S. Cl. 455/3.02

(57) ABSTRACT

A vehicle-based communications device acquires identification information, such as a phone number, from a cellular phone located within the vehicle and transmits that information to a call center where it is processed and stored so that the call center can subsequently establish a voice link with the cellular phone. The communications device generally includes a control circuit, an acquisition device for acquiring the identification information according to one of several methods, and a data transceiver for transmitting a data signal to the call center via a satellite network. The communications device can acquire identification information from a plurality of cellular phones so that those phones may be prioritized and called back in a particular order.

### FIELD OF THE INVENTION

The present invention generally relates to a communications device for communicating between a vehicle and a call center, and more particularly, to a communications device that acquires the phone numbers of one or more cellular phone(s) located within the vehicle and sends those number(s) to the call center via a satellite network.

### BACKGROUND OF THE INVENTION

Communications or telematics devices are currently used by vehicle electronic systems and/or occupants for communicating with remote vehicle call centers. In some applications, the communications or telematics device allows the vehicle occupants to call a remote call center for one of a number of reasons, including instances where the vehicle has broken down, the vehicle has run out of fuel, or an occupant requests directions or activates a panic button, to name but a few. In other applications, the communications or telematics device automatically notifies the call center in the case of an emergency event such as when the system detects an airbag deployment, etc.

In some instances, a vehicle communications or telematics device can exchange voice data, in addition to electronic data, with a call center through a satellite network. In order to provide both voice and data communication, the communications or telematics device must possess certain hardware and pay for the use of certain networks that will support such communication, which can increase the cost of the device itself as well as the cost of operation.

One alternative is cellular networks, which can be used to provide both voice and electronic data. Although the cost of using a cellular network for exchanging voice and electronic data may be less than that for using a satellite network, certain drawbacks may still exist. For instance, many areas in the United States and other countries still do not have comprehensive and reliable cellular coverage, particularly in sparsely populated areas.

### SUMMARY OF THE INVENTION

According to one aspect of the invention, there is provided a communications device for communicating between a vehicle and a call center that generally having a control circuit, an acquisition device and a data transceiver. The acquisition device acquires identification information from at least one cellular phone located within the vehicle, and provides an identification signal to the data transceiver generally representative of the identification information. The data transceiver communicates with the call center via a satellite network and provides a data signal to the call center generally representative of the identification information.

According to another aspect, there is provided a communications network for use by a vehicle occupant generally having a cellular phone located within a vehicle, a communications device installed on the vehicle, a call center, a satellite network for communicating a data signal between the communications device and the call center, and a cellular network for communicating a voice signal between the call center and the cellular phone.

According to yet another aspect, there is provided a method of acquiring and transferring identification information pertaining to a cellular phone to a call center.

Some examples of objects, features and advantages of this invention include, but are certainly not limited to, providing a vehicle-installed communications device that: utilizes a reliable, relatively low-cost satellite network to established a data link with a call center, utilizes a voice link between a call center and a cellular phone located within the vehicle in order to avoid including unnecessary voice link circuitry in the communications device and thereby provide a relatively low-cost voice link, is capable of acquiring identification information from a plurality of cellular phones located within the vehicle and prioritizing the cellular phones according to one or more methods so that, if necessary, they may be contacted in a particular order, utilizes an acquisition device capable of acquiring identification information from one or more cellular phones according to one of a number of different methods, and that provides a design that is of relatively simple design, economical manufacture and operation, is serviceable, and has a long and useful life in service, to name but a few. Of course, it is not necessary that a particular embodiment of the present invention incorporate each and every one of the above-listed objects, features and advantages, as that list is simply a recitation of some of the qualities of various embodiments of the present invention. Moreover, a particular embodiment of the present invention may have additional objects, features and advantages beyond the exemplary ones listed above.

### BRIEF DESCRIPTION OF THE DRAWINGS

These and other objects, features and advantages of the present invention will be apparent from the following detailed description of the preferred embodiments and best mode, appended claims and accompanying drawings, in which:

FIG. 1 shows a communications network generally having a vehicle-installed communications device, a satellite network, a call center, a cellular network and at least one cellular phone; and

FIG. 2 is a schematic diagram of an embodiment of the communications device of FIG. 1 and a typical cellular phone.

### DETAILED DESCRIPTION OF THE PREFERRED EMBODIMENTS

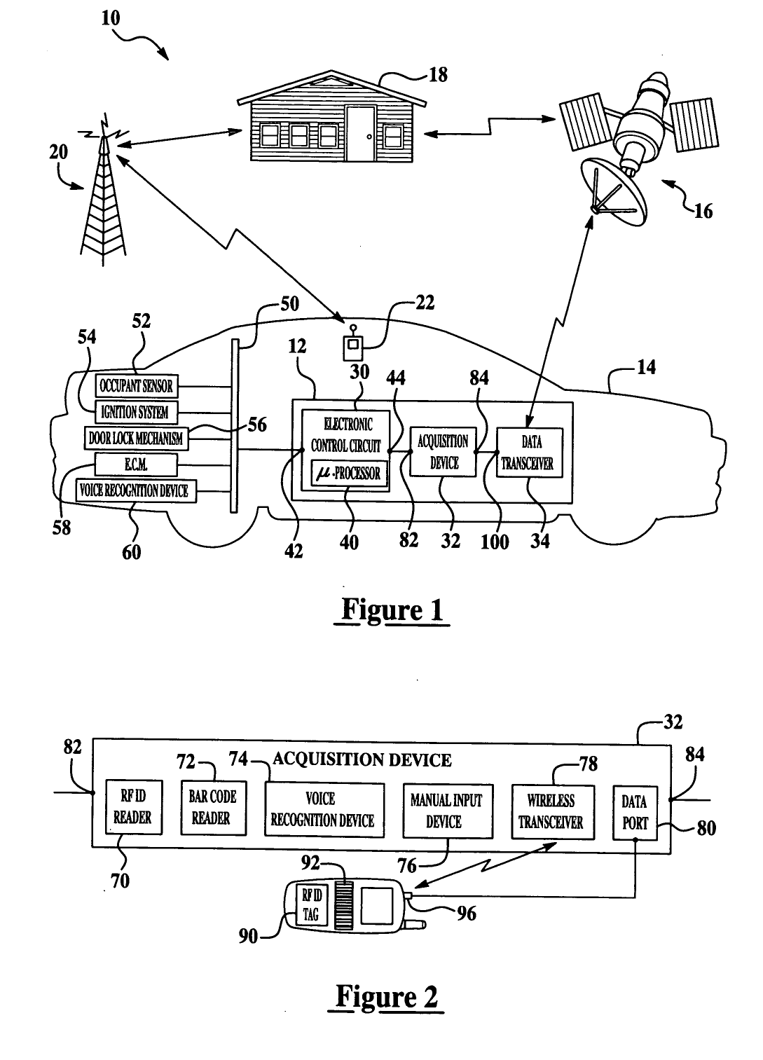

Referring to FIG. 1, there is shown an embodiment of a communications network 10 utilizing the vehicle-installed communications device 12 taught herein, however, a number of other networks known to those skilled in the art could be used as well. Communications network 10 provides for reliable, low-cost data and voice communication and generally includes a communications device 12 installed in a vehicle 14, a satellite network 16, a call center 18, a cellular network 20 and one or more cellular phones or handsets 22.

Communications device 12 is preferably a telematics-type device capable of acquiring identification information, such as phone numbers, from one or more cellular phones 22 located within vehicle 14 and transferring that identification information to call center 18 via satellite network 16. This transfer of information to call center 18 preferably occurs before communications device 12 alerts call center 18 of a subsequent emergency event. Thus, if an emergency event does occur, such as the deployment of a vehicle airbag or the sending of a distress signal by an occupant, call center 18 will already be in possession of the identification information and will be able to promptly contact the corresponding cellular phone(s) 22 in order to establish a voice link over cellular network 20. According to the particular embodiment shown here, communications device 12 generally includes an electronic control circuit 30, an acquisition device 32 and a data transceiver 34.

Electronic control circuit 30 provides processing and logic capabilities for communications device 12, and is capable of executing various types of electronic instructions. According to a preferred embodiment, electronic processing device 30 includes a microprocessor 40, a signal input/output 42 for communicating with a bus 50, a signal input/output 44 for communicating with acquisition device 32, and any number of other components known to those skilled in the art such as electronic memory devices, bios components, etc. Examples of suitable microprocessors include the OMAP-family of processors sold by Texas Instruments. This family of processors includes scalable integrated applications-, communication- and stand-alone application-based processors that are designed to deliver maximum performance with little power consumption. Of course, other processors may be used as well, as the above-mentioned family of processors is only provided for purposes of illustration.

Signal input/output 42 allows electronic control circuit 30 to communicate with a number of different devices, networks and/or systems 52-60 via bus 50, which can be a CAN bus or any other suitable bus means. One reason for providing such communication is so that control circuit 30 can monitor various aspects of vehicle 14 and can determine when an event has occurred which requires acquisition device 32 to gather identification information from cellular phone 22. For example, communications device 12 could be set up such that simply turning on the vehicle causes the acquisition device 32 to query cellular phone 22. In such an arrangement, electronic control circuit 30 is coupled to ignition system 54 via input/output 42 and bus 50 in order to determine when the vehicle has been started. According to another example, communications device 12 could be designed such that acquisition device 32 interrogates cellular phone 22 for identification information as soon as an occupant's presence is sensed in the vehicle. Accordingly, control circuit 30 would need to be in communication with occupant sensor 52. The pair of illustrations provided above are only two examples of the types of devices, systems and/or networks that communications device 12 can be coupled to, as numerous other examples, including but not limited to the following examples, also exist.

According to the exemplary embodiment shown in FIG. 1, control circuit 30 is coupled to an occupant sensor 52, a vehicle ignition system 54, an electronic door lock mechanism 56, an engine control module (ECM) 58 and a voice recognition device 60 so that any one of these devices, networks and/or systems can sense an event or condition that causes the control circuit to instruct acquisition device 32 to acquire identification information from cellular phone 22. Signals from door lock mechanism 56 indicating that the door locks have been activated, signals from ECM 58 indicating a certain engine condition, or signals from voice recognition device 60 in response to the recognition of a human voice, for instance, could all be used to initiate the information acquisition process. Again, it should be appreciated that control circuit 30 can be coupled to any combination of different devices, systems and/or networks on a vehicle, not just the particular exemplary embodiment shown here.

Once control circuit 30 has been alerted of a certain initialization event or condition by one of the devices, systems and/or networks, such as 52-60 mentioned above, it sends an initialization signal via signal input/output 44 to acquisition device 32. An ‘initialization signal’ is broadly defined as any signal (whether it be conducted by a wired, wireless or any other connection) which causes acquisition device 32 to try and acquire identification information from one or more cellular phones 22 located within the vehicle.

Acquisition device 32 acquires identification information from one or more cellular phones 22 located within vehicle 14 in response to receiving the initialization signal from control circuit 30, and can do so according to a number of different methods. The ‘identification information’ broadly includes all types of information that can be used by call center 18 in order to contact cellular phone 22. For instance, the phone number associated with each cellular phone 22 constitutes identification information, as does a serial or other identification number so long as it can be indexed or otherwise cross-referenced to provide a corresponding phone number. Once the identification information has been collected by acquisition device 32, that device sends an electronic identification signal to data transceiver 34 so that the transceiver can further relay the identification information to call center 18. According to the particular embodiment shown in FIG. 2, acquisition device 32 includes electronic readers 70 and 72, a voice recognition device 74, a manual entry device 76, a wireless transceiver 78, a data port 80 and signal input/outputs 82, 84.

Electronic reader 70 is preferably a radio frequency identification (RFID) transceiver that wirelessly acquires identification information from an RFID tag or transponder 90 associated with each cellular phone 22. RFID tag 90 is a small electronic component having an internal antenna which enables it to receive and respond to radio frequency (RF) queries from electronic reader 70, and can be of the passive type (requires no internal power) or the active type (requires internal power). Excitation of RFID tag 90 by electronic reader 70 causes the tag to provide the requested identification information. Numerous types of RFID transceivers are available, including the MF-RC530 model offered by Philips.

Optical reader 72 is preferably a barcode scanner that uses a laser to wirelessly gather identification information from a barcode 92 associated with each cellular phone 22. The identification information is encoded on barcode 92 through the use of a combination of bars and spaces each having specific widths which represent different alpha-numeric symbols. RFID tags 90 and/or barcodes 92 could be printed on adhesive-backed stickers which a user could attach to each of the cellular phones 22 that they intend on using with communications device 12. If the cellular phone 22 comes pre-equipped with an RFID tag or a barcode, then additional ones would not be needed. One example of a suitable barcode scanner is the LHM 2127 model sold by Opticon.

Voice recognition device 74 preferably includes a microphone and any necessary hardware and software so that it may acquire identification information pertaining to one or more cellular phones 22 by communicating with a vehicle occupant. Device 74 detects and interprets human speech by monitoring the microphone for sound, converting a detected sound into digitized information, and processing the digitized information in much the same way as a voice-activated telephone menu system. It is also possible to provide voice recognition device 74 such that it simply captures and digitizes a sound and then sends a corresponding signal to electronic control circuit 30 for further analysis. In any event, the processing of the human voice results in the extraction of the identification information, which is preferably the cellular phone number.

If a less automated method is desirable, then a manual input device 76, which can be anything from a keypad (wired or wireless) to existing controls on the vehicle instrumentation, allows the occupant to manually enter the identification information into acquisition device 32. A number of different arrangements could be used, for instance when ignition system 54 informs control circuit 30 that the vehicle has been started, the occupant could be prompted to manually enter the phone number of cellular phone 22 into a keypad or use the buttons of the vehicle radio or other instrumentation to enter that number. According to another embodiment, previously registered phone numbers are shown on a display with the last one that was used being highlighted or otherwise identified. The user is able scroll through these numbers and either make a selection or enter a new phone number via a keypad or other manual entry device. An example of a suitable manual input device is a touch-activated key pad that uses a wireless WLAN network such as Bluetooth, Zigbee, WI-FI, infrared, etc.

Wireless transceiver 78 can be used to interrogate cellular phone 22 such that it wirelessly gathers the requested identification information from the cellular phone upon pairing. In this embodiment, both cellular phone 22 and wireless transceiver 78 would need to be equipped with some type of wireless transceiver or other component so that when transceiver 94 is interrogated it can provide the requested identification information. It is also possible to provide a wireless dongle for plugging into the data port on cellular phone 22 so that phones which are not Bluetooth-enabled, etc. could still communicate with wireless transceiver 78. The use of a common dongle with multiple connection adaptors for different handset models can simplify pairing between the dongle and acquisition device 32 and provides non Bluetooth-enabled phones some of the same benefits as those that are Bluetooth-enabled. The wireless transceiver 78 could be designed to automatically detect the presence of certain types of wireless signals within the vehicle such that capturing a local area wireless signal triggers an initialization event. Examples of different wireless protocols that may be used include Bluetooth, Zigbee, WI-FI, infrared or others known to those skilled in the art, and an example of a suitable wireless transceiver 78 is the CXN-1000 chip sold by Sony Semiconductor.

Data port 80 preferably includes a serial or parallel connection 96 for plugging into cellular phone 22 so that the identification information can be transferred over a wired interface. Connection 96 could be a standard parallel connection such as those found on most cellular phones, or it could be a cradle or docking station for receiving cellular phone 22. In any event, the data port 80 queries cellular phone 22 and receives the requested identification information over a wired connection.

It should be appreciated that even though acquisition device 32 is shown having components 70-80, not all of these particular components are needed on a single acquisition device. Acquisition device 32 may include one of a number of different combinations of components, including those shown in FIG. 2 as well as components not shown but known in the art. Furthermore, each of the devices 70-80 is preferably capable of both detecting the presence of a cellular phone and gathering identification information from the cellular phone. Therefore, instead of one of the devices 52-60 being the source of initialization which causes acquisition device 32 to attempt and acquire the identification information from the cellular phone, the acquisition device itself could be that source of initialization so that it attempts to acquire the identification information in response to detecting the presence of a cellular phone.

Data transceiver 34 uses satellite network 16 to transmit and receive data-only signals with call center 18, including a data signal which contains the identification information relating to one or more cellular phones 22 located within the vehicle. An example of a suitable satellite network 16 is the data only communications network owned and operated by Orbcomm which utilizes a constellation of thirty or more low earth orbit (LEO) satellites along with a global network of ground stations to provide cost-effective tracking, monitoring and messaging capabilities throughout the world. Broadly speaking, data transceiver 34 includes a signal input/output 100 for receiving the identification signal from acquisition device 32, transceiver circuitry (not shown) for establishing data-only communication with call center 18 and an antenna (not shown), as well as other circuits and components commonly found in such systems. By using data transceiver 34, dependable, affordable satellite-based (as opposed to cellular-based) data communication can be established with a vehicle located anywhere in the world, without the additional expense associated with voice communication circuitry.

In addition to providing a data signal that includes identification information, data transceiver 34 interfaces with electronic control circuit 30 to provide various types of relevant vehicle information to the call center. For example, data transceiver 34 may provide emergency data from one of the devices, systems and/or networks 52-60 in order to alert the call center of events such as air bag deployment or empty fuel situations, or it may convey information such as the location of the vehicle or any other relevant information that might enable the call center to assist the vehicle occupants. One type of data transceiver that may be used for the satellite communication is a DS-100 or DS-300 satellite modem offered by the assignee of the present application, Delphi Corporation.

In operation, communications device 12 detects an initialization event and sends an initialization signal to acquisition device 32 in response. As previously explained, the initialization event can be one of many different types of events or conditions including one sensed by one of the devices 52-60, it could be the presence of a cellular phone sensed by one of the components 70-80, or it could be in the form of an instruction sent by call center 18, to name but a few. In any case, the initialization event causes electronic control circuit 30 to instruct acquisition device 32 to attempt and gather identification information from the cellular phone(s) 22 by sending it an electronic initialization signal via signal input/outputs 44, 82.

Acquisition device 32 then attempts to acquire identification information, which is preferably in the form of a phone number, from one or more cellular phones 22 located within the vehicle. Again, the acquisition device may use one of the several components 70-80 and corresponding techniques previously described in order to the gather the identification information, or it may use an alternative technique known to those skilled in the art. If acquisition device 32 is able to obtain the sought after identification information, then the acquisition device sends an electronic identification signal containing that information to data transceiver 34 via signal input/outputs 84 100. If, on the other hand, communications device 12 is set up to retrieve identification information other than a phone number (such as a serial number), then device 12 can either cross-reference the identification information and directly obtain a corresponding phone number or it can simply send the identification information to call center 18 for subsequent cross-referencing. In those instances where acquisition device 32 is unable to gather the identification information, an operator alert such as a visual or audio alert can be used to prompt the occupant to enter the identification information using one or more of the devices 70-80 previously described. If electronic control circuit 30 is equipped with electronic memory then the identification information can be stored at the communications device 12 and/or call center 18.

Once the identification signal is received, data transceiver 34 uses its antenna and satellite network 16 to convey a data signal carrying identification information pertaining to one or more cellular phones 22 to call center 18. Because this communication is being conveyed over a satellite network, as opposed to a cellular network, the communication can generally be expected to be more dependable and secure. As those skilled in the art will appreciate, data transceiver 34 can also be used to convey other data to call center 18 including diagnostic information about the vehicle, as well as emergency signals from the vehicle or occupant, etc. According to a first embodiment, data transceiver 34 sends the data signal to call center 18 shortly after receiving the identification signal from acquisition device 32. While according to a second embodiment, the data transceiver sends the identification information at a later time; preferably at a time when it is already sending another signal such as an emergency signal so that the multiple signals may be bundled into a single transmission.

Upon receiving the data signal from data transceiver 34, call center 18 preferably stores the identification information and performs any cross-checking or other activities necessary for determining the status of the corresponding cellular phone. Being in possession of the identification information beforehand enables the call center to immediately try and establish a voice link over cellular network 20 in the event that a subsequent event or condition is detected which requires voice contact with the vehicle occupants. If no data signal or a corrupted data signal is received by call center 18, then the call center can initiate a data request by sending communications device 12 a signal over satellite network 16.

It is oftentimes the case that multiple cellular phones 22 will be present within the vehicle at a given time, and having the phone numbers of each of these phones may be more desirable than having a single cellular phone number. According to a preferred embodiment, communications device 12 is capable of acquiring and transmitting identification information regarding multiple cellular phones, that way in the event of an emergency the call center has several possible voice links which can be established. According to one embodiment, call center 18 simply tries contacting and establishing a voice link with each of the cellular phones simultaneously. According to a slightly more complex embodiment, the multiple cellular phones 22 are prioritized such that they are called in a particular order. One way of prioritizing is to cross-reference the newly acquired identification information with previously registered vehicle ownership data to determine if the cellular phone of the vehicle owner or primary user is currently in the vehicle. If it is in the vehicle, then that cellular phone, followed by other phone numbers previously registered, would be contacted first.

According to a different method of prioritizing, call center 18 utilizes stored data from previous data signals to determine the frequency with which particular cellular phones have been previously found within a particular vehicle. For instance, if three cellular phones 22 are located within vehicle 14 and a first one of those phones has been sensed a total of ten times previously, a second phone has been sensed a total of two previous times, and a third cellular phone has never been sensed in this particular vehicle, then call center 18 would first try and contact the first cellular phone, as that phone most likely belongs to the driver and is therefore the most likely to still be located within the vehicle, followed by the second and third phones, respectively.

According to another priority method, the time at which each cellular phone 22 was last detected determines priority so that those phones most recently detected are called first. Generally, the cellular phone most recently located within the vehicle probably has the highest likelihood of still being present there. For example, if acquisition device 32 gathered identification information on a first cellular phone several minutes ago, that phone would generally have a higher likelihood of still being located within the vehicle than a second cellular phone located several hours ago, assuming all other things equal. Thus, in the event of an emergency or other event, call center 18 would contact cellular phones 22 in decreasing order of when they were sensed.

Numerous other prioritizing methods could be utilized by call center 18, including methods of prioritizing based on the data acquisition method (i.e.—identification information gathered by one of components 70-80 has a higher priority than that gathered by another component), methods based on wireless signal strength (i.e.—those phones having the highest signal strength and using wireless transceiver 78 are most likely to be located in a certain part of the vehicle), and methods based on a previously recognized voice (i.e.—those phones associated with a certain human voice (vehicle owner, previous user of the system, etc.) have a higher priority than those associated with an unknown voice), to name but a few of the prioritizing methods possible.

It will thus be apparent that there has been provided a communications device for communicating between a vehicle and a call center, as well as a method of operation, which achieve the aims and advantages specified herein. It will of course be understood that the foregoing description is only of preferred exemplary embodiments, and that the invention is not limited to the specific embodiments shown.

I claim:

1. A communications device for communicating between a vehicle and a call center, comprising:
a control circuit having an output;
an acquisition device for acquiring identification information from at least one cellular phone located within the vehicle, having an input coupled to the control circuit output and an output for providing an identification signal generally representative of the identification information; and
a data transceiver for communicating with the call center via a satellite network, having an input coupled to the acquisition device output for receiving the identification signal and an antenna for providing a data signal generally representative of the identification information.

2. The communications device of claim 1, wherein the data transceiver sends the data signal to the call center via the satellite network so that the call center is in possession of the identification information before the call center is alerted of an event requiring it to contact the communications device.

3. The communications device of claim 1, wherein the control circuit provides an initialization signal to the acquisition device in response to either sensing the presence of an occupant via an occupant sensor, or recognizing a human voice via a voice recognition device.

4. The communications device of claim 1, wherein the acquisition device includes an electronic reader for acquiring the identification information from a radio frequency identification device (RFID) tag associated with the cellular phone.

5. The communications device of claim 1, wherein the acquisition device includes an optical reader for acquiring the identification information from a bar code associated with the cellular phone.

6. The communications device of claim 1, wherein the acquisition device includes a voice recognition device for acquiring the identification information by communicating with an occupant in the vehicle.

7. The communications device of claim 1, wherein the acquisition device is capable of acquiring identification information from a plurality of cellular phones located within the vehicle.

8. The communications device of claim 7, wherein the call center prioritizes the plurality of cellular phones according to a predetermined method.

9. The communications device of claim 8, wherein the predetermined method includes the steps of determining if any of the plurality of cellular phones currently detected in the vehicle have been previously detected in that same vehicle, and establishing priority such that if a first cellular phone has been previously detected in that vehicle more frequently than a second cellular phone then it is given a higher priority.

10. The communications device of claim 8, wherein the predetermined method includes the steps of determining how recently each of the plurality of cellular phones was detected in that vehicle, and establishing priority such that if a first cellular phone was detected in that vehicle more recently than a second cellular phone then it is given a higher priority.

11. The communications device of claim 8, wherein the predetermined method includes the steps of determining the particular method of acquisition used to acquire the identification information from each of the plurality of cellular phones, and establishing priority such that if the identification information of a first cellular phone was acquired according to a predetermined method and the identification information of a second cellular phone was acquired by a different method then the first cellular phone is given a higher priority.

12. The communications device of claim 1, wherein the satellite network is a low earth orbit satellite network that transmits data only.

13. A communications network for use by a vehicle occupant, comprising:
a cellular phone located within a vehicle;
a communications device installed on the vehicle, comprising:
a control circuit having an output;
an acquisition device for acquiring identification information from the cellular phone, having an input coupled to the control circuit output and an output for providing an identification signal generally representative of the identification information; and
a data transceiver having an input coupled to the acquisition device output for receiving the identification signal and an output for providing a data signal generally representative of the identification information;
a call center located remotely from the vehicle;
a satellite network for communicating the data signal between the communications device and the call center; and
a cellular network for communicating a voice signal between the call center and the cellular phone, wherein upon recognition of an initialization event, the acquisition device acquires the identification information from the cellular phone and provides the identification signal to the data transceiver, the data transceiver transmits the data signal via the satellite network, and the call center stores and processes the identification information so that it may subsequently establish a voice link with the cellular phone via the cellular network.

14. The communications network of claim 13, wherein the acquisition device is capable of acquiring identification information from a plurality of cellular phones located within the vehicle.

15. The communications network of claim 14, wherein the call center prioritizes the plurality of cellular phones according to a predetermined method.

16. A method of acquiring and transferring identification information pertaining to a cellular phone to a call center, comprising the steps of:
a) generating an initialization signal;
b) identifying at least one cellular phone located in a vehicle in response to the initialization signal;
c) acquiring the identification information from the cellular phone;
d) generating an identification signal generally representative of the identification information;
e) generating a data signal generally representative of the identification signal and transmitting the data signal to a call center via a satellite network; and
f) extracting the identification information from the data signal and storing the identification information at the call center so that the call center can contact the cellular phone.

17. The method of claim 16, wherein steps b) and c) further include identifying a plurality of cellular phones located within the vehicle and acquiring identification information from the plurality of cellular phones.

18. The method of claim 17, wherein the call center prioritizes the plurality of cellular phones according to a predetermined method.
